(19) United States
(12) Patent Application Publication
(10) Pub. No.: US 2017/0056800 A1
(43) Pub. Date: Mar. 2, 2017

(54) FILTER ASSEMBLY FOR PROVIDING PURIFIED AIR

(71) Applicant: Airgle Corporation, Flushing, NY (US)

(72) Inventor: Yang Zhen Lo, Flushing, NY (US)

(21) Appl. No.: 14/703,893

(22) Filed: May 5, 2015

(51) Int. Cl. B01D 46/00; B01D 46/42; F24F 3/16; B01D 46/52

(52) U.S. Cl. CPC B01D 46/0005; B01D 46/0021; B01D 46/521; B01D 46/4227; F24F 3/1603

(57) ABSTRACT

Disclosed is the filter assembly for providing purified air to an enclosed space. The filter assembly including enclosed filter housing for regulating the flow of the air having an inlet port to receive the air, an outlet port for releasing the purified air to the enclosed space, and a hollow chamber within the inlet port and the outlet port. The filter assembly includes a high efficiency particulate air filter unit replacably inserted in the hollow chamber to purify the air. The high efficiency particulate air filter unit includes a first high efficiency particulate air filter, a second high efficiency particulate air filter attached to the first high efficiency particulate air filter, a third high efficiency particulate air filter attached to the second high efficiency particulate air filter, and a fourth high efficiency particulate air filter attached to the third high efficiency particulate air filter.

### BACKGROUND OF THE INVENTION

1. Field of the Invention

The present invention generally relates to an air purification assembly, and more particularly to a filter assembly for providing purified air to an enclosed space.

2. Description of Related Art

In recent years, air pollution has become one of the most serious problems affecting the world. Numerous studies have established that the quality of air in the majority of cities is rated as un-healthy. Air pollution possesses a significant risk factor for a number of health conditions such as respiratory infections, lung cancer, COPD, stroke and heart disease.

Air pollution may be caused due to anthropogenic sources such as vehicles or due to natural sources such as dust from large areas of land with few or no vegetation, smoke, methane, etc. Children aged less than five years that live in developing countries are the most affected in terms of total deaths attributable to indoor and outdoor air pollution.

Mechanical collectors, bag houses, particulate scrubbers, electrostatic precipitators, NOx controllers are commonly used as pollution control devices in industries and transportation. These devices can either destroy contaminants or remove them from an exhaust air stream before it is emitted into the atmosphere.

However, these pollution control devices are associated with various problems like, the collector plates tend to get covered in dust and airborne residues and are difficult to clean. The plates may need hosing down, soaking, vacuum cleaning, or going through the dishwasher every few months to maintain efficiency.

Currently, commercial grade air purifiers such as small stand-alone units or larger units that can be affixed to an air handler unit (AHU) or to an HVAC unit are used for removing airborne particles in the medical, industrial, and commercial industries. These air purifiers are composed of the filters, air inlet and exhaust ports and a variety of pipes and fitting components. In operation, one or more fans cause air to be drawn through the filter(s) and emitted through an outlet.

High efficiency particulate air (HEPA) filters have gained popularity for use in air purifiers directed to consumers as they remove particles having a size equal to or greater than 0.3 microns particles. The arrangement of the HEPA filters should be such that no air bypasses the HEPA filter.

Also, the filters used in air purifiers require replacement, so it is important to have filters which can be easily removed and replaced. A replaced filter must be properly installed if it is to function properly.

Therefore, there exists a need make a filter assembly with plurality of high efficiency particulate air filter units which can be replaced easily at once and the dust does not fall freely into the surrounding environment causing secondary pollution. Further, the filter assembly providing purified air to an enclosed space has been designed to facilitate user convenience.

### SUMMARY OF THE INVENTION

In accordance with the teachings of the present invention, a filter assembly for providing purified air to an enclosed space is provided.

An object of the present invention is to provide the filter assembly including enclosed filter housing for regulating the flow of the air having an inlet port to receive the air, an outlet port for releasing the purified air to the enclosed space, and a hollow chamber within the inlet port and the outlet port.

The filter assembly includes a high efficiency particulate air filter unit replacably inserted in the hollow chamber to purify the air. The high efficiency particulate air filter unit includes a first high efficiency particulate air filter, a second high efficiency particulate air filter attached to the first high efficiency particulate air filter, a third high efficiency particulate air filter attached to the second high efficiency particulate air filter, and a fourth high efficiency particulate air filter attached to the third high efficiency particulate air filter.

The first, second, third and fourth high efficiency particulate air filter are arranged together to form a W-shaped configuration for releasing the filtered air. The first high efficiency particulate air filter and the second high efficiency particulate air filter attached to form a first space and the third high efficiency particulate air filter and the fourth high efficiency particulate air filter attach to form a second space. The first space and the second space collect the filtered particulate or dust.

Another object of the present invention is to provide a dust holding unit configured within the hollow chamber to hold and prevent the filtered particulate fall off during removal of the high efficiency particulate air filter unit from the hollow chamber.

Another object of the present invention is to provide plurality of locking units to hold the high efficiency particulate air filter unit against the enclosed filter housing. Further, the filter assembly includes one or more handles to easily move and place the housing from place to another.

Another object of the present invention is to provide fastening units for fastening the walls of the enclosed filter together and further facilitating the insertion and the removal of the high efficiency particulate air filter unit from the enclosed filter housing.

Further features and advantages of the present invention, as well as the structure and operation of various embodiments of the present invention, are described in detail below with reference to the accompanying drawings.

### BRIEF DESCRIPTION OF DRAWINGS

FIG. 1 illustrates a perspective view of a filter assembly for providing purified air to an enclosed space, in accordance with the preferred embodiment of the present invention;

FIG. 2A illustrates a side view of a high efficiency particulate air filter unit, in accordance with the preferred embodiment of the present invention;

FIG. 2B illustrates another magnified side view of a high efficiency particulate filter unit, in accordance with an exemplary embodiment of the present invention;

FIG. 3A illustrates a front perspective view of the enclosed filter housing, in accordance with the preferred embodiment of the present invention; and

FIG. 3B illustrates a rear view of the enclosed filter housing, in accordance with the preferred embodiment of the present invention.

The foregoing summary, as well as the following detailed description of certain embodiments of the present invention, will be better understood when read in conjunction with the appended drawings. For the purpose of illustrating the invention, certain embodiments are shown in the drawings. It should be understood, however, that the present invention is not limited to the arrangements and instrumentality shown in the attached drawings.

### DETAILED DESCRIPTION OF DRAWINGS

While this technology is illustrated and described in a preferred embodiment, a filter assembly for providing purified air to an enclosed space, may be produced in different sizes, shapes and colors. This is depicted in the drawings, and will herein be described in detail, as a preferred embodiment of the invention, with the understanding that the present disclosure is to be considered as an exemplification of the principles of the invention and the associated functional specifications for its construction and is not intended to limit the invention to the embodiment illustrated. Those skilled in the art will envision many other possible variations within the scope of the technology described herein.

Reference will now be made in detail to several embodiments of the invention which are illustrated in the accompanying drawings. Wherever feasible and convenient, the same reference numerals are used in the figures and the description to refer to the same or like parts. The drawings are in a simplified form and not to precise scale. For purposes of convenience and clarity only, directional terms, such as top, bottom, left, right, up, down, over, above, below, beneath, rear, and front may be used with respect to the accompanying drawings. In addition, words such as attached, affixed, coupled, connected and similar terms with their inflectional morphemes are used interchangeably, unless the difference is noted or made otherwise clear from the context. These words and expressions do not necessarily signify direct connections, but include connections through mediate components and devices.

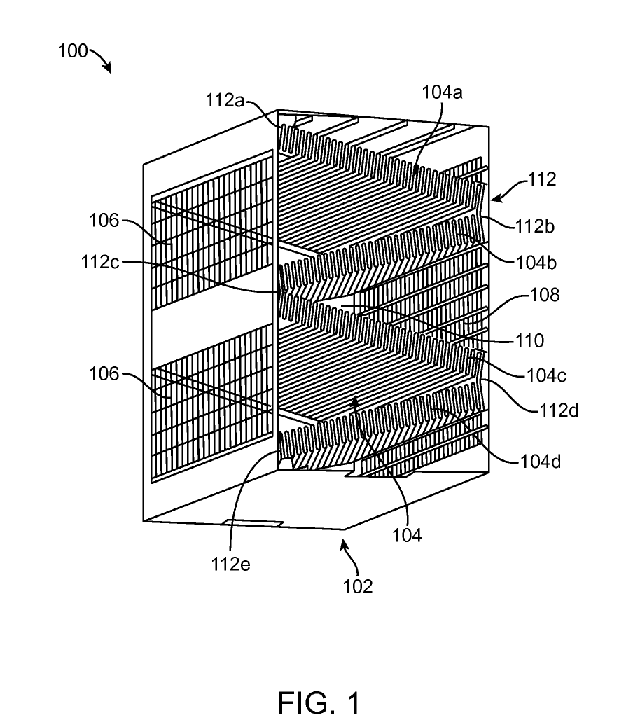

FIG. 1 illustrates a perspective view of a filter assembly 100 for providing purified air to an enclosed space, in accordance with the preferred embodiment of the present invention. The filter assembly 100 includes an enclosed filter housing 102 for regulating the flow of air and a high efficiency particulate air filter unit 104 detachably attached inside the enclosed filter housing 102 to purify the air.

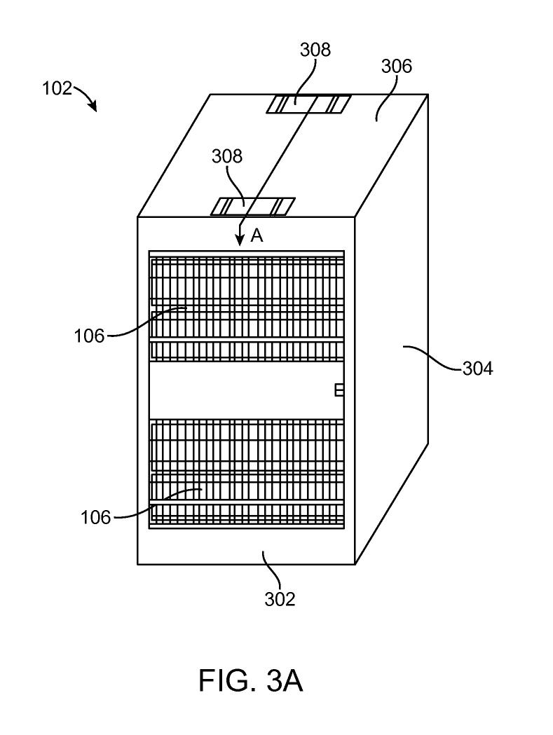

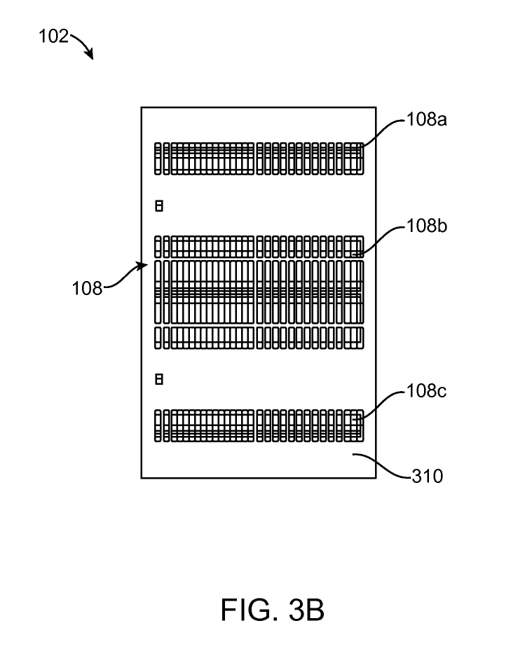

The enclosed filter housing 102 includes an inlet port 106 receives the air, an air outlet port 108 releases the purified air and a hollow chamber 110 within the inlet port 106 and the outlet port 108 for receiving the high efficiency particulate air filter unit 104. The inlet port 106 and outlet port 108 is explained in detail in conjunction with FIG. 3A and FIG. 3B respectively of the present invention.

The high efficiency particulate air filter unit 104 includes a first high efficiency particulate air filter 104a, a second high efficiency particulate air filter 104b attached to the first high efficiency particulate air filter 104a, a third high efficiency particulate air filter 104c attached to the second high efficiency particulate air filter 104b, and a fourth high efficiency particulate air filter 104d attached to the third high efficiency particulate air filter 104c.

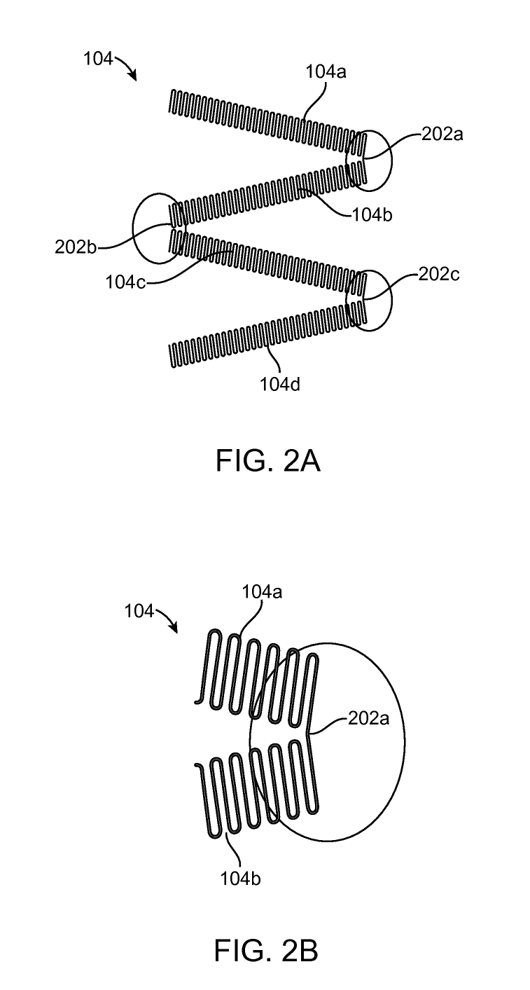

The first high efficiency particulate air filter 104a, the second high efficiency particulate air filter 104b, the third high efficiency particulate air filter 104c and the fourth high efficiency particulate air filter 104d are arranged together to form a W-shaped configuration for releasing the filtered air. The high efficiency particulate air filter unit 104 is explained in detail in conjunction with FIG. 2A of the present invention.

The air enters the housing 102 through the inlet port 106 and is filtered through the high efficiency particulate air filter unit 104 and moves out from the outlet port 108. The filtered particulate is collected within a first space created in between the first high efficiency particulate air filter 104a and the second high efficiency particulate air filter 104b and within a second space created in between the third high efficiency particulate air filter 104c and the fourth high efficiency particulate air filter 104d. The first space and the second space is explained in detail in conjunction with FIG. 2A of the present invention.

In another embodiment of the present invention the filter apparatus 100 includes plurality of locking units 112 such as first locking unit 112a, second locking unit 112b, third locking unit 112c, fourth locking unit 112d and fifth locking unit 112e to hold the high efficiency particulate air filter unit 104 against the enclosed filter housing 102.

In a preferred embodiment of the present invention the filter assembly 100 includes the high efficiency particulate air filter unit 104 adapted to be cleaned and reused. For example, during use the high efficiency particulate air filter unit 104 may left with a little surface for the absorption of the impurities from the air. So, the high efficiency particulate air filter unit 104 is removed with ease at once from the housing 102 as it is a single unit in W shaped configuration and thus may be cleaned and reused.

The high efficiency particulate air filter unit 104 may remove particles present in the air that have a size of 0.3 micrometers (μm) in diameter. The high efficiency particulate air filter unit 104 may have many applications in various fields like medical facilities, automobiles, aircraft and homes. However it will be readily apparent to those skilled in the art that the various uses of the high efficiency particulate air filter unit 104 may be envisioned without deviating from the scope of the present invention.

In a preferred embodiment of the present invention, the locking units 112 are configured as grooves on the length of inner side of the housing 102. The high efficiency particulate air filter unit 104 is removable along the length of the housing 102 from the locking units 112. The W-shaped high efficiency particulate air filter unit 104 is removed all together from the housing 102.

FIG. 2A illustrates a side view of a high efficiency particulate air filter unit 104, in accordance with the preferred embodiment of the present invention. The first high efficiency particulate air filter 104a is connected with the second high efficiency particulate air filter 104b at a point 202a. The second high efficiency particulate air filter 104b is connected with the third high efficiency particulate air filter 104c at a point 202b. The third high efficiency particulate air filter 104c is connected to the fourth high efficiency particulate air filter 104d at a point 202c.

The attachment at the point 202a, point 202b and point 202c facilitates easy placement and removal of the high efficiency particulate air filter unit 104 from the housing (not shown in FIG. 2A). The attachment at point 202a, point 202b and point 202c further protects the flow of air to pass through and thus the air passes only through the high efficiency particulate air filter 104.

The attachment of at least two high efficiency particulate air filters 104 may be made through integral sequential connection or sequentially connected split connector. However, it would be readily apparent to those skilled in the art that various types of attachment may be made without deviating from the scope of the present invention.

FIG. 2B illustrates another side view of a high efficiency particulate filter unit 104 in accordance with another preferred embodiment of the present invention. The high efficiency particulate air filter unit 104 is in the form of a NEPA-media sheet folded into a plurality of small pleats.

The number of pleats per inch and the size of the pleats may vary according to requirements required for the purifying the air in the enclosed space. Examples of the number of pleats per inch may include but not limited to 8 Pleats per inch, 5 pleats per inch and the sizes may also vary like 2.0″ and 2.5″ mini-pleat media packs. However those one skilled in the art will envision many other possible variations of the HEPA media sheet within the scope of the technology described herein.

In another exemplary embodiment of the present invention, the number of the high efficiency particulate air filter units may vary, for example one W-shaped high efficiency particulate air filter unit may be arranged in side-by-side relationship presenting a plurality of W-shaped high efficiency particulate air filter units to form a filter assembly for providing purified air to an enclosed space.

FIG. 3A illustrates a front perspective view of the enclosed filter housing 102 displaying the inlet port 106, in accordance with the preferred embodiment of the present invention. In a preferred embodiment the inlet port 106 is an opening in the enclosed housing to receive the air and then transferring the air to get purified through the high efficiency particulate filter unit (not shown in FIG. 3A). Generally, the inlet port 106 is a mesh structure to receive the air from the enclosed space.

In a preferred embodiment, the enclosed housing 102 is rectangular in shape, having a front wall 302, right side wall 304, top wall 306, rear wall (not shown in FIG. 3A), left side wall (not shown in FIG. 3A) and bottom wall (not shown in FIG. 3A). However, it would be readily apparent to those skilled in the art that various shapes of the housing 102 may be envisioned without deviating from the scope of the present invention.

The walls 302, 304, and 306 of the enclosed filter housing 102 are releasably fastened together using fastening units such as screws, hooks, velcro, and other fastening means. The inlet port 106 is configured on the front wall 302. In a preferred embodiment of the present invention, the right side wall 304 may be opened by removing fastening units for inserting and removing of the high efficiency particulate air filter unit (not show in FIG. 3A). However, it would be readily apparent to those skilled in the art that any wall of the housing 102 may be removed to insert and remove the high efficiency particulate air filter unit (not show in FIG. 3A).

In another preferred embodiment of the present invention, the one or more handles 308 are configured to facilitate easy movement and placement of the housing 102 from one place to another. Further, it would be known to those skilled in the art that handles 308 facilitates a user to move and place the housing 102 in the installation field (such as ceiling, air duct etc). The handles 308 may be made of any shape and size to facilitate receiving of the fingers to move the housing 102.

FIG. 3B illustrates a rear view of the enclosed filter housing 102 displaying the outlet port 108, in accordance with the preferred embodiment of the present invention. The outlet port 108 is a mesh structure opening in the enclosed filter housing 102 to release the purified air to the enclosed space.

The outlet port 108 is configured on the rear wall 310 of the enclosed housing 102. However, it would be readily apparent to those skilled in the art that the outlet port 108 may be configured on any of the wall of the enclosed housing 102 without deviating from the scope of the present invention.

In a preferred embodiment of the present invention, the outlet port 108 includes a first mesh structure 108a, a second mesh structure 108b, and a third mesh structure 108c to release maximum purified air along the length of the rear wall 310. The outlet port 108 is rectangular in shape. However, it would be readily apparent to those skilled in the art that various shape of outlet port 108 may be envisioned without deviating from the scope of the present invention.

There has thus been shown and described a filter assembly for providing purified air to an enclosed space. Many changes, modifications, variations and other uses and applications of the subject invention will, however, become apparent to those skilled in the art after considering this specification and the accompanying drawings which disclose the preferred embodiments thereof. All such changes, modifications, variations and other uses and applications which do not depart from the spirit and scope of the invention are deemed to be covered by the invention, which is to be limited only by the claims which follow.

1. A filter assembly for providing purified air to an enclosed space, the filter assembly comprising:
an enclosed filter housing for regulating the flow of the air having an inlet port to receive the air; an outlet port for releasing the purified air to the enclosed space; and a hollow chamber within the inlet port and the outlet port; and
a high efficiency particulate air filter unit replacably inserted in the hollow chamber to purify the air, the high efficiency particulate air filter unit comprising:
a first high efficiency particulate air filter initiating from the edge of the inlet port to meet the outlet port;
a second high efficiency particulate air filter extending from the first high efficiency particulate air filter from the outlet port end to meet the inlet port, wherein in between the first high efficiency particulate air filter and the second high efficiency particulate air filter a first space is created to receive air from the inlet port;
a third high efficiency particulate air filter extending from the second high efficiency particulate air filter from the inlet port end to meet the outlet end port; and
a fourth high efficiency particulate air filter extending from the third high efficiency particulate air fitter from the outlet port end to meet the inlet port, wherein in between the third high efficiency particulate air filter and the fourth high efficiency particulate air filter a second space is created to receive air from the inlet port;
characterize in that, the first high efficiency particulate air filter cartridge, the second high efficiency particulate air filter cartridge, the third high efficiency particulate air filter cartridge and the fourth high efficiency particulate air filter cartridge continuously arranged together to form a W-shaped configuration for releasing the filtered air through the output port;
wherein the first space and the second space collects the filtered particulate.

3. The filter assembly according to claim 1 further comprising plurality of locking units to hold the high efficiency particulate air filter unit against the enclosed filter housing.

4. The filter assembly according to claim 1 further comprising one or more handles on the enclosed filter housing adapted to facilitate moving and placement of the housing.

5. The filter assembly according to claim 1 further comprising fastening units for fastening the walls of the enclosed filter housing together, and further facilitates insertion and the removing of the high efficiency particulate air filter unit from the enclosed filter housing.
